(19) United States
(12) Patent Application Publication
(10) Pub. No.: US 2026/0262878 A1
(43) Pub. Date: Sep. 10, 2026

(54) AUTOMATIC KIOSK AND A METHOD OF OPERATING SAME

(71) Applicant: YISSUM RESEARCH DEVELOPMENT COMPANY OF THE HEBREW UNIVERSITY OF JERUSALEM LTD., Jerusalem (IL)

(72) Inventors: Oded SHOSEYOV, Jerusalem (IL); Vladislav SHUMEIKO, Jerusalem (IL)

(73) Assignee: YISSUM RESEARCH DEVELOPMENT COMPANY OF THE HEBREW UNIVERSITY OF JERUSALEM LTD., Jerusalem (IL)

(21) Appl. No.: 18/993,636

(22) PCT Filed: Jul. 13, 2023
(86) PCT No.: PCT/IL2023/050735

§ 371 Date: Jan. 13, 2025

Related U.S. Application Data
(60) Provisional application No. 63/368,304, filed on Jul. 13, 2022.

(51) Int. Cl. A47J 36/32; A47J 44/00

(52) U.S. Cl. CPC A47J 36/321; A47J 44/00

(57) ABSTRACT

An automatic cooking device is disclosed. The cooking device comprises: (i) a cooking chamber capable of holding a closable cooking container configured to hold at least one dry ingredient; (ii) a liquid supply unit for providing a predetermined amount of liquid to the cooking container; (iii) an energy source configured to provide energy to a mixture of the at least one dry ingredient and the liquid inside the cooking container when placed in the cooking chamber; (iv) a vibration generator configured to vibrate the mixture of the at least one dry ingredient and the liquid inside the cooking container in the cooking chamber; and (v) a controller configured to control the a liquid supply unit, the energy source and the vibration generator.

### CROSS REFERENCE TO RELATED APPLICATIONS

This application claims the benefit of priority of U.S. Provisional Patent Application No. 63/368,304 filed on Jul. 13, 2022, the contents of which are incorporated herein by reference in their entirety.

### FIELD OF THE INVENTION

The present invention relates generally to automatic cooking devices. More specifically, the present invention relates to an automatic kiosk and a method of operating same.

### BACKGROUND OF THE INVENTION

Automatic food machines (also known as, automatic kiosks, or food vending machines) are everywhere, in offices, hospitals clinics, airports, etc. Most of these machines sell ready-to-use products, such as snacks, sweets, soft drinks, etc. with little to no nutritive value. Cooked meals are complicated to be automatically cooked on the spot.

Newly automatic kiosks capable of selling cooked meals are equipped with a microwave oven capable of de-frosting frozen cooked meals. These automatic kiosks are also equipped with large freezers for holding frozen cooked meals and a conveying system for delivering a selected frozen meal to be defrosted. These automatic kiosks are large, expensive, and heavy energy consumers. In case of electricity breakdown, the entire stoke of frozen cooked meals is wasted. Furthermore, these automatic kiosks are limited in the variety of meals offered.

Accordingly, there is a need for the development of automatic kiosks that cook fresh meals from dry ingredients, which are easily stored at room temperature and have long self-life. For this solution, a new automatic kiosk is suggested.

### SUMMARY OF THE INVENTION

Some aspects of the invention are related to an automatic cooking device comprising: (i) a cooking chamber capable of holding a closable cooking container configured to hold at least one dry ingredient; (ii) a liquid supply unit for providing a predetermined amount of liquid to the cooking container; (iii) an energy source configured to provide energy to a mixture of the at least one dry ingredient and the liquid inside the cooking container when placed in the cooking chamber; (iv) a vibration generator configured to vibrate the mixture of the at least one dry ingredient and the liquid inside the cooking container in the cooking chamber; and (v) a controller configured to: receive instructions to cook a meal; control the provision of the cooking container with the at least one dry ingredient to the cooking chamber: control the provision of the predetermined amount of liquid to the cooking container from the liquid supply unit; and control the operation of the energy source and the vibration generator based on the received instructions to cook the meal.

In some embodiments, the cooking device further comprises a housing containing elements (i) to (v).

In some embodiments, the controller is further configured to associate the received instructions to cook the meal with at least one of the following parameters: power of the energy source; duration of operation of the energy source; frequency of the vibration generator; an amplitude of the vibration generator; and vibration type.

In some embodiments, the cooking device further comprises at least one sensor configured to sense at least one of: a property of a mixture, and a property of the cooking container inside the cooking chamber; and wherein the controller is further configured to: receive, from the at least one sensor, measurements of the property; and control the operation of the energy source and the vibration generator also based on the received measurements.

In some embodiments, the at least one dry ingredient is freeze-dried. In some embodiments, the cooking device further comprises at least one ingredient container containing the at least one dry ingredient. In some embodiments, the at least one dry ingredient is stored in the at least one ingredient container at room temperature. In some embodiments, the at least one ingredient container comprises at least one of humidity sensor and an oxygen sensor. In some embodiments, the controller is configured to control at least one of humidity level and an oxygen level inside the at least one ingredient container based on measurements from at least one of the humidity sensor and the oxygen sensor.

In some embodiments, the cooking device further comprises at least one storage container containing cooking containers filled with at least one dry ingredient. In some embodiments, the cooking containers are stored at room temperature. In some embodiments, the at least one storage container comprising at least one of a humidity sensor and an oxygen sensor. In some embodiments, the controller is configured to control at least one of humidity level and an oxygen level inside the at least one storage container based on measurements from at least one of the humidity sensor and the oxygen sensor.

In some embodiments, the housing comprises an inlet for inserting the ingredients and an outlet covered by a door for extracting a cooked meal. In some embodiments, the housing is characterized by a width of between 30 to 100 cm, a length of between 50 to 500 cm, and a height of between 100 to 400 cm.

In some embodiments, the cooking container comprises an inlet for receiving the at least one dry ingredient. In some embodiments, the cooking container comprises an inlet for receiving the liquid. In some embodiments, the cooking container comprises a release exit for releasing excess vapor pressure. In some embodiments, the cooking container comprises a detachable cover to extract a cooked meal.

In some embodiments, the liquid supply unit comprises a pre-heating unit. In some embodiments, the pre-heating unit is configured to heat the liquid to a temperature of between 25° C. and 95° C.

In some embodiments, the energy source is a microwave generator, and the cooking chamber is a microwave cavity. In some embodiments, the energy source is an induction heater, and the cooking container comprises a metallic magnetic insert. In some embodiments, the energy source is IR radiation. In some embodiments, at least a portion of the cooking container is transparent to IR radiation.

In some embodiments, the vibration generator generates vibration at a frequency of between 10 Hz and 600 kHz. In some embodiments, the sensor is selected from: IR Camera, pressure sensor, CMOS camera, CCD camera, temperature sensor, vibration sensor, humidity sensor, volume sensor, and pH sensor. In some embodiments, the temperature sensor is a thermocouple at least one of: insertable and attached to the cooking container.

In some embodiments, the cooking device further comprises at least one conveyor configured to convey the cooking container to the cooking chamber.

Some additional aspects of the invention may be directed to a method of controlling automatic cooking device to cook a meal comprising: receiving instructions to cook a meal; providing a cooking container and at least one dry ingredient to a cooking chamber; supplying a predetermined amount of liquid to the cooking container from a liquid supply unit, thereby obtaining a mixture; determining at least one property of the mixture, based on measurements received from at least one sensor; and operating an energy source to provide energy to the mixture and a vibration generator to provide vibrations to the mixture based on the determined property; thereby obtaining the cooked meal.

In some embodiments, the providing comprises adding the at least one dry ingredient, form an ingredient container, at a desired amount to the cooking container. In some embodiments, the desired amount is based on the meal to be cooked. In some embodiments, the providing comprises providing to the cooking container a first dry ingredient at a first amount from a first dry ingredient container and a second dry ingredient at a second amount from a second dry ingredient container. In some embodiments, the providing comprises receiving a cooking container from a storage container, wherein the cooking container comprises the at least one dry ingredient.

In some embodiments, the method may further include a type of cooking container based on the meal to be cooked and wherein providing a cooking container is from a storage container associated with the meal to be cooked.

In some embodiments, the predetermined amount of water is received from a lookup table and determined based on the meal to be cooked.

Some additional aspects of the invention may be directed to a microwave oven, comprising: a microwave cavity; a microwave source; and a vibration generator configured to vibrate a load placed in the microwave cavity, and wherein the vibration generator comprising a vibration motor rotating at 10 to 10000 RPM, having a shift of 1 mm to 150 mm, at a weight of between 0.1 to 2000 grams.

In some embodiments, the microwave oven further comprises at least one sensor for sensing a property of a load placed in the microwave cavity; and a controller configured to: receive measurements of the property from the at least one sensor; and control at least the vibration generator to vibrate the load based on the received measurements. In some embodiments, the controller is further configured to control the microwave source based on the received measurements. In some embodiments, the at least one sensor is a temperature sensor. In some embodiments, the controller is configured to control at least one of, the vibration generator and the microwave source to provide substantially homogeneous heating to the load.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of an automatic cooking device according to some embodiments of the invention;

FIG. 2 is an illustration of another automatic cooking device according to some embodiments of the invention;

FIG. 3 is an illustration of yet another automatic cooking device according to some embodiments of the invention;

FIGS. 4A and 4B are computer simulations of an automatic kiosk and a cooking container according to some embodiments of the invention;

FIG. 5 is an illustration of a microwave oven according to some embodiments of the invention;

FIG. 6 is a block diagram of a controller for an automatic cooking device according to some embodiments of the invention; and

FIG. 7 is a flowchart of a method of controlling an automatic cooking device according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Some aspects of the invention may be directed to a new automatic cooking device (e.g., an automatic kiosk) capable of cooking fresh meals on-demand and on-the-spot from dry ingredients. Such an automatic cooking device may be equipped with a novel microwave oven (or any other suitable oven) capable of both heating and stirring the cooked food.

As used herein a “dry ingredient” may include an edible product dehydrated, using any known method, to having at most 20 wt % humidity. For example, a dry ingredient may be dried food, selected from dry fruit, dry vegetables, dry lentils, dry dairy products, dry meat, dry fish, dry beans, dry spices, and the like. For example, freeze dried pea, corn, pepper, mushrooms, broccoli, carrots, spinach, cheese, meat, potatoes, and various other vegetables. granola, muesli, dry fruits, dry vegetables, seeds,, polysaccharides such as arabinoxylans, xyloglucans, cellulose etc.) powders (for example, oat powder, nuts powders, protein powder (like whey protein, casein protein, pea proteins, plant-based proteins etc.)), as well as dried fruits (raisin, bananas, blueberries etc.) and whole foods like nuts, oat flakes etc.). In another example, the dry food ingredient may include pre-cooked and then dehydrated foods like quinoa, buckwheat, couscous, pasta/noodles, rice, amaranth, barley, bulgur, farro, freekeh, kamut, spelt. and the like.

In some embodiments, one or more dry ingredients may be introduced into a cooking container, a predetermined amount of liquid may be added to the one or more dry ingredients in the cooking container which is then placed in a cooking chamber. When place inside a cooking chamber the cooking container comprising a mixture of the one or more dry ingredients and the liquid may be heated and stirred to receive a ready-to-eat cooked meal, in for example, less than 10 minutes (e.g., less than, 2 minutes, 3 minutes, 4 minutes, 5 minutes, 6 minutes, 7 minutes and any value in-between).

As used herein a “cooking container” may include any closable vessel that can hold the one or more dry ingredients and the liquid. The cooking container may include an opening to allow the introduction of at least the liquid prior to the cooking. When closed the cooking container may be capable of holding water vapors in a closed environment and include a release valve for releasing excess vapor from the container. The cooking container can be disposable or reusable. For example, a disposable cooking container may be made from a biodegradable material (e.g., a biodegradable polymeric composite). In yet another example, an office may include a washing machine for washing reusable cooking containers, and users may reload clean cooking containers into the automatic cooking device.

In some embodiments, the cooking container may include a bowl and a cover. In some embodiments, at least one of the bowl and the cover may be disposable. In some embodiments, the cooking container may be made from dielectric materials for use in a microwave oven. In some embodiments, the cooking container may include at least a portion (e.g., a window in the bowl or the cover, the entire bowl or the entire cover, or both) transparent to IR radiation to be heated by an IR source. In some embodiments, the cooking container may include a metallic element capable of being warmed by induction heating.

As used herein a “liquid” may refer to any edible liquid that may be added to the dry ingredients. For example, the liquid may be water, milk, juice, wine, beer, broth, oil, and the like.

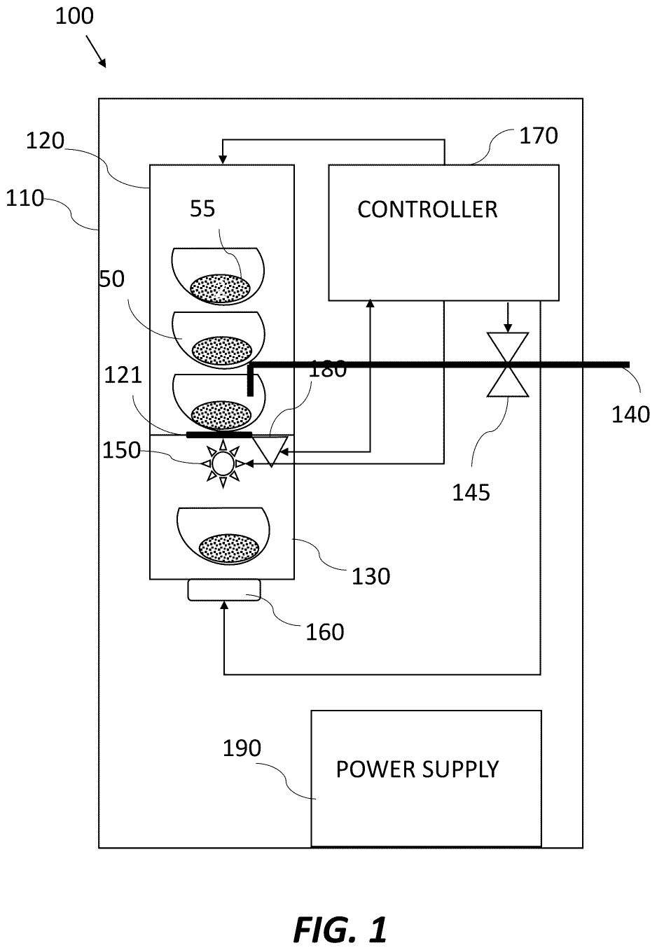

Reference is now made to FIG. 1 which is an illustration of an automatic cooking device (e.g., an automatic kiosk) according to some embodiments of the invention. An automatic cooking device 100 may include a cooking chamber 130, a liquid supply system 140, an energy source 150, a vibration generator 160; and a controller 170 all being contained in a housing 110.

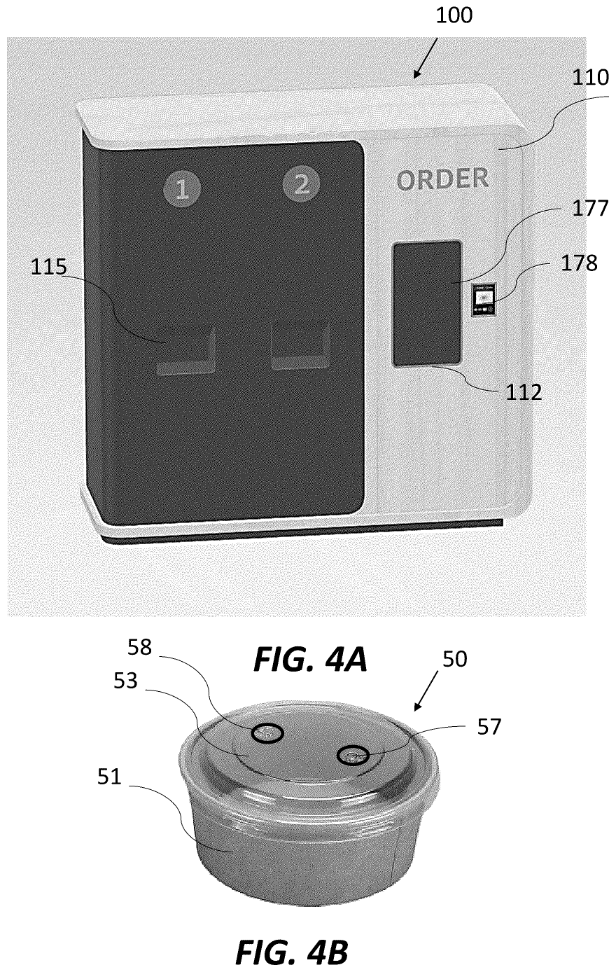

In some embodiments, housing 110 may be dimensioned to be placed in various locations, such as but not limited to, offices, hospitals clinics, airports, universities, schools, colleges, army bases and the like. For example, the housing may have a width of between 30 to 100 cm, a length of between 50 to 500 cm, and a height of between 100 to 400 cm. A simulated illustration showing a nonlimiting example for housing 110 and a detailed disclosure regarding housing 110 is given with respect to FIG. 4A.

In some embodiments, cooking chamber 130 is capable of holding a closable cooking container 50 configured to hold at least one dry ingredient 55. Cooking chamber 130 may be designed to allow energy to be introduced into cooking container 50 for cooking a mixture of at least one dry ingredient 55 with a liquid. In some embodiments, cooking chamber 130 is a microwave over, therefore may be dimensioned to allow microwaves to resonate in the chamber. In some embodiments, cooking chamber 130 may be an IR oven, and optionally may include at least one reflective wall for reflecting IR radiation. In some embodiments, cooking chamber 130 may be an induction heating oven.

In some embodiments, a single dry ingredient 55 or a mixture of dry ingredients 55 may be added into cooking container 50. For example, a predetermined amount of dry pasta, dry tomato powder, and dry spices may be added in relative amounts, suitable for forming a cooked pasta with tomato sauce. In some embodiments, different cooking containers 50 may be preloaded with specific mixtures of dry ingredients 55 each configured to produce a specific meal according to a specific recipe. In such case, automatic cooking device 100 may further include a storage container 120 for holding the pre-loaded cooking containers 50 filled with at least one dry ingredient 55. In some embodiments, automatic cooking device 100 may include two or more storage containers 120 each for providing different types of cooking containers 50 pre-loaded with dry ingredients for different types of meals. For example, automatic cooking device 100 may include 4 storage containers 120, a first storage container 120 for storing a first type of cooking container 50 holding dry ingredients for cooking pasta with tomato sauce, a second storage container 120 for storing a second type of cooking containers 50 holding dry ingredients for cooking pasta with broccoli, a third storage container 120 for storing a third type of cooking containers 50 holding dry ingredients for cooking rice noodles with shiitake mushrooms, and, a fourth storage container 120 for storing a fourth type of cooking containers 50 holding dry ingredients for cooking pasta Bolognese.

In some embodiments, storage containers 120 may not require any additional cooling and all cooking containers 50 may be stored at room temperature. In some embodiments, the humidity and/or oxygen levels in at least one storage container 120 may be monitored. In some embodiments, the humidity and/or oxygen levels of all storage containers 120 may be monitored. For example, at least one storage container 120 may include at least one of, humidity sensor and an oxygen sensor (not illustrated). In some embodiments, all storage containers 120 may be housed in a main compartment, and wherein monitoring the humidity and/or oxygen levels is for the entire compartment, using for example, a single set of humidity sensor and an oxygen sensor. In some embodiments, measurements from the at least one of, humidity sensor and an oxygen sensor may be sent to controller 170 for further monitoring and the controller may send alerts, to an external user device, if the humidity and/or oxygen levels exceed threshold levels.

In some embodiments, the humidity levels may be controlled passively by adding silica gel, or molecular sieve to at least sone of storage containers 120 or to the main compartment. In some embodiments, the oxygen and humidity levels may be actively controlled, for example, by providing ventilation (e.g., by fans, blowers, etc.) one or all ingredient containers 120, for example, based on the humidity level and the oxygen level measurements.

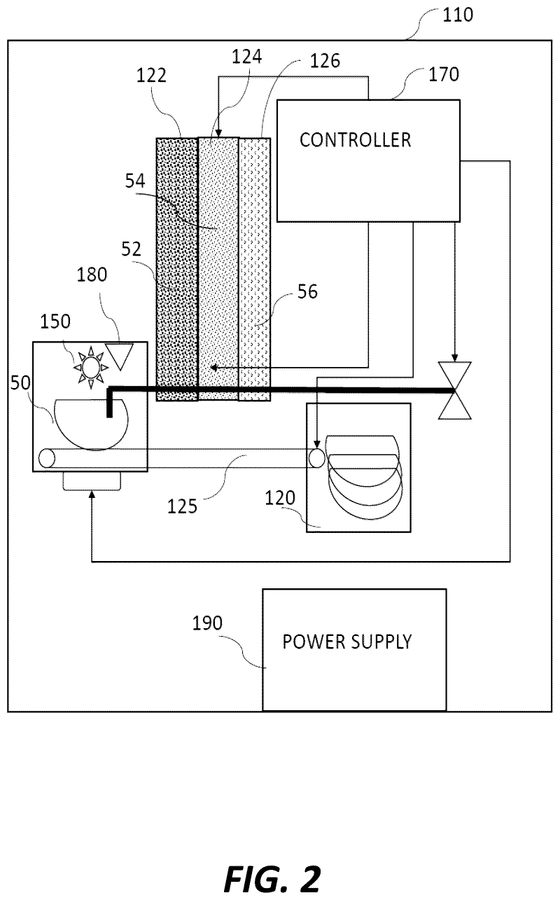

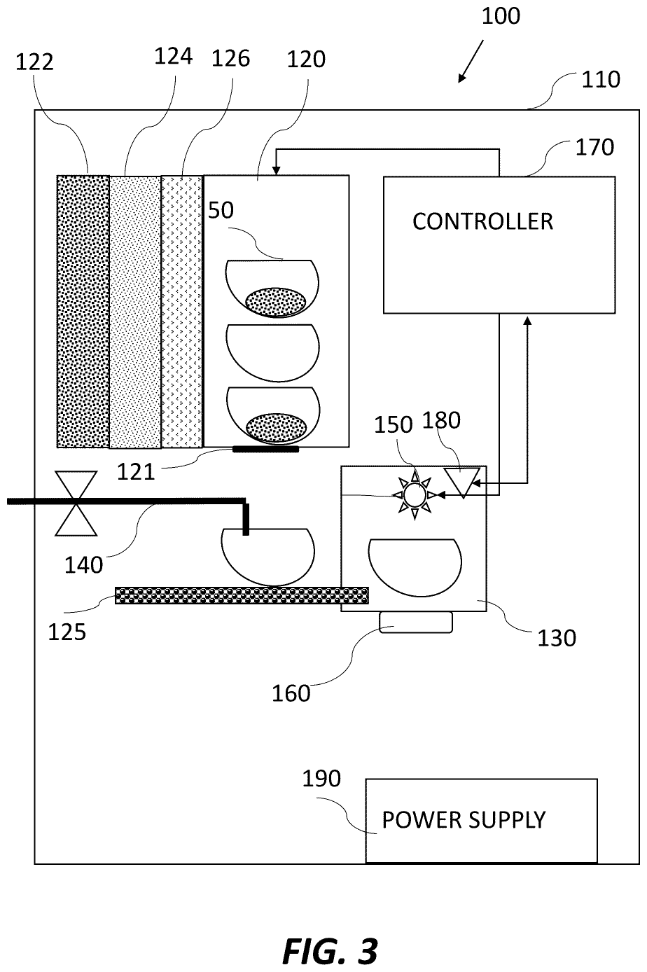

In some embodiments, storage container 120 may include a closable opening 121 for providing cooking container 50 from storage container 120 into cooking chamber 130. In some embodiments, automatic cooking device 100 may further include at least one conveyor 125 configured to convey cooking container 50 to cooking chamber 130, as illustrated and discussed with respect to FIGS. 2 and 3.

In some embodiments, liquid supply unit 140 may be configured to provide a predetermined amount of liquid to cooking container 50. In some embodiments, liquid supply unit 140 may include a controllable valve 145 for controlling the amount of liquid provided to cooking container 50. In some embodiments, liquid supply unit 140 may be in liquid connection to a reservoir (e.g., a bear barrel, a wine barrel, a water tank, etc.) of liquids that may or may not be located inside housing 110. In a nonlimiting example, liquid supply unit 140 may be in liquid connection to a liquid supply system (e.g., water pipes).

In some embodiments, liquid supply unit 140 may be configured to provide the predetermined amount of liquid to cooking container 50 when placed in cooking chamber 130. In such case, a liquid pipe may be inserted via a wall of cooking chamber 130. The pipe may include a nozzle for providing the liquid into a corresponding opening in cooking container 50. The nozzle may be located at a predetermined location inside cooking chamber 130. Alternatively, the nozzle may be located outside cooking chamber 130, as illustrated, and the predetermined amount of liquid may be provided to cooking container 50 prior to the placement of cooking container 50 in cooking chamber 130.

In some embodiments, liquid supply unit 140 may comprise a pre-heating unit (not illustrated). The pre-heating unit may be configured to heat the liquid to a temperature of between 25° C. and 95° C. Some nonlimiting examples for pre-heating units may include, a resistive heater (e.g., a boiler), a microwave heater, an IR heater, and the like. In some embodiments, the pre-heating unit may further used to clean the nozzle of liquid supply unit 140, by a stream of boiled/hot water. Alternatively, the nozzle may be disinfected/cleaned using other devices, such as, an ultraviolet lamp and the like.

In some embodiments, energy source 150 may be configured to provide energy to a mixture of the at least one dry ingredient 55 and the liquid inside cooking container 50 when placed in cooking chamber 130. In some embodiments, energy source 150 is a microwave generator (e.g., a magnetron, a solid state microwave generator, etc.) and cooking chamber 130 is a microwave cavity. In some embodiments, energy source 150 is an induction heater, and cooking container 50 comprises a metallic magnetic insert. In some embodiments, energy source 150 is an IR radiation source (e.g., an IR lamp) and at least a portion of cooking container 50 is transparent to IR radiation, for example, a cover of cooking container 50 may be at least partially transparent to IR radiation.

In some embodiments, vibration generator 160 may include any device that may vibrate, shake, stir, bounce, mix, and the like, the mixture of at least one dry ingredient 55 and the liquid inside cooking container 50 in the cooking chamber 130. In a nonlimiting example vibration generator 160 may be connected to a bottom of cooking chamber 130 (as illustrated) and may be configured to vibrate cooking container 50 placed on the bottom. In yet another nonlimiting example, vibration generator 160 may include or may be connected to an arm (not illustrated) configured to hold and shake cooking container 50.

In some embodiments, vibration generator 160 may generate vibration at a frequency of between 10 Hz to 600 kHz. For example, vibration generator 160 may vibrate at frequencies between 10 to 100 Hz, 200 to 300 Hz, 300 to 1000 Hz, 1000 Hz to 50 kHz, 20 Kz, to 150 Kz, 100 kHz to 300 kHz, 200 kHz to 600 kHz and any value in between.

In a nonlimiting example, vibration generator 160 may rotate at between 10 to 100RPM, 50 to 500 RPM, 100 to 1000 RPM, 500 to 1500 RMP, 500 to 2000 RMP, 1000 to 3000 RPM, 1000 to 3500 RPM, 2000 to 4000 RPM, 3000 to 5000 RPM, 4000 to 10000 RPM, and any value in between.

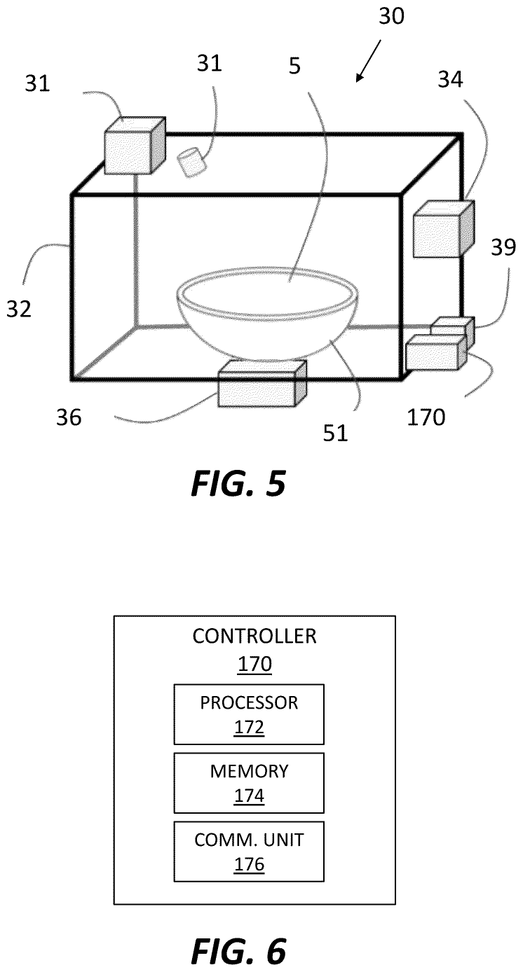

Some additional nonlimiting examples for a vibration generator 160 are given and discussed with respect to FIG. 5.

In some embodiments, controller 170 may be configured to: receive instructions to cook a meal; control the provision of cooking container 50 with the at least one dry ingredient 55 to cooking chamber 130; control the provision of the predetermined amount of liquid to cooking container 50 from the liquid supply unit 140; and control the operation of energy source 150 and vibration generator 160 based on the received instructions to cook the meal.

As used herein, instructions to cook a meal may include, choosing a mixture of dry ingredients and/or instructions to mix specific dry ingredients, as discussed with respect to FIGS. 2 and 3, add a predetermined amount of liquid (optionally also select the type of liquid), heat and stir the dry ingredients and liquid mixture.

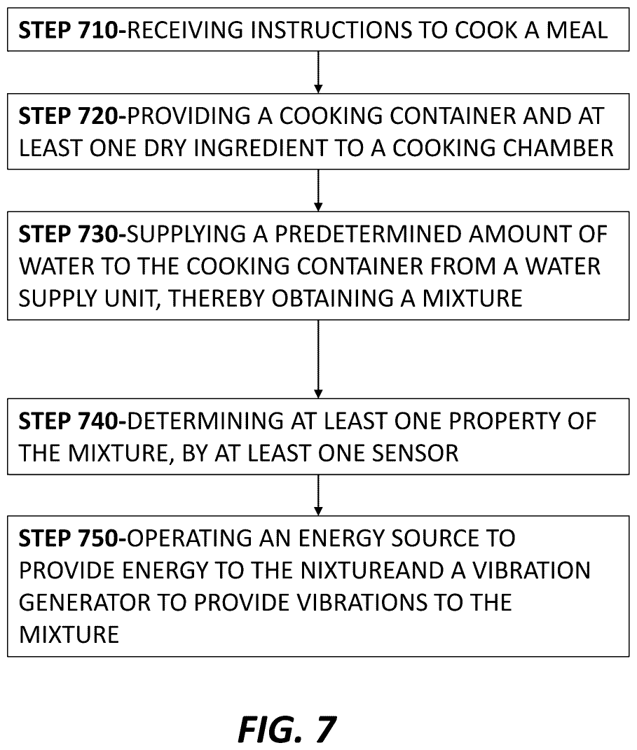

In some embodiments, controller 170 may include or may be in communication with a user interface 176 (illustrated in FIG. 4A) that may be configured to receive instructions to cook a meal from a user. In some embodiments, controller 170 may be configured to associate the received instructions to cook the meal with at least one of the following parameters: power of the energy source; duration of operation of the energy source; duration of operation of the vibration generator, frequency of the vibration generator; an amplitude of the vibration generator; and vibration type. As further discussed with respect to the method of FIG. 7.

A detailed disclosure disclosing controller 170 is given with respect to FIG. 6 hereinbelow.

In some embodiments, automatic cooking device 100 may further include at least one sensor 180 configured to sense at least one of: a property of the liquid and one or more dry ingredients mixture, and a property of the cooking container. For example, sensor 180 may be selected from, a temperature sensor (e.g., an IR\thermal sensor, an IR\thermal camera, a thermocouple, etc.) an optical camera, a humidity sensor, a pressure sensor, and the like. In some embodiments, sensor 180 may be located inside cooking chamber 130. In some embodiments, sensor 180 may be located outside cooking chamber 130, and cooking chamber 130 may further include a transparent window allowing one of IR\thermal sensor, an IR\thermal camera and optical camera to capture an image of cooking container 50 inside cooking chamber 130. In some embodiments, the window may be covered by a transparent material or may include an opening in cooking camber 130.

In some embodiments, controller 170 may be configured to receive from at least one sensor 180, measurements of the property; and control the operation of energy source 150 and vibration generator 160 also based on the received measurements. In some embodiments, the proposition of energy/vibrations may be conducted during the entire cooking process, but not necessarily continuously.

In some embodiments, automatic cooking device 100 may further include a power supply unit 190 for providing electrical power to the various components of automatic cooking device 100. In some embodiments, power supply unit 190 may be connected to the grid and/or may include a battery.

Reference is now made to FIG. 2, which is an illustration of another automatic cooking device according to some embodiments of the invention. Automatic cooking device 100 may include a cooking chamber 130, a liquid supply system 140, an energy source 150, a vibration generator 160; and a controller 170 all being contained in a housing 110. Cooking chamber 130, liquid supply system 140, energy source 150, vibration generator 160; and controller 170 may be substantially the same components discussed above with respect to FIG. 1. In some embodiments, automatic cooking device 100 may further include a sensor such as sensor 180 and a power source 190.

In some embodiments, automatic cooking device 100 may include at least one ingredient container containing the at least one dry ingredient, for example, ingredient containers 122, 124, and 126. In a nonlimiting example, ingredient container 122 may contain dry ingredient 52 (e.g., dry rice), ingredient container 124 may contain dry ingredient 54 (e.g., dry lentil), and ingredient container 126 may contain dry ingredient 56 (e.g., a mixture of spices). In some embodiments, one or more dry ingredients 52, 54 and 56 are stored in one or more ingredient containers 122, 124, and 126 at room temperature. No additional refrigeration is required. In some embodiments, one or more ingredient containers 122, 124, and 126 may include at least one of a humidity sensor and an oxygen sensor. In some embodiments, controller 170 is configured to monitor at least one of the humidity level and the oxygen level inside one or more ingredient containers 122, 124, and 126 based on measurements from at least one of the humidity sensor and the oxygen sensor.

In some embodiments, the humidity levels may be controlled passively by adding silica gel, or molecular sieve to at least one of the ingredient containers 122, 124 and 124. In some embodiments, the oxygen and humidity levels may be actively controlled, for example, by providing ventilation (e.g., by fans, blowers, etc.) to one or all ingredient containers 122, 124 and 124, for example, based on the humidity level and the oxygen level measurements.

In some embodiments, automatic cooking device 100 may include a cooking container storage 120, for storing empty cooking containers 50 to be filled with one or more dry ingredients 52, 54, and 56 from one or more ingredient containers 122, 124 and 126. In some embodiments, automatic cooking device 100 may include a conveyor 125 for conveying cooking container 50 from storage 120. In some embodiments, filling cooking container 50 with one or more dry ingredients 52, 54, and 56 is done inside cooking chamber 130. Alternatively, filling cooking container 50 with one or more dry ingredients 52, 54, and 56 is done prior to the placement of cooking container 50 inside cooking chamber 130, for example, during traveling on the conveyor (as illustrated). In some embodiments, each one of storage 120 and one or more ingredient containers 122, 124, and 126 may include a controllable opening (e.g., a door, valve, a doser, etc.), and controller 170 may control these controllable openings to provide an empty cooking container 50 from storage 120, and fill the empty cooking container with predetermined amounts of one or more dry ingredients 52, 54 and 56 according to a specific recipe. As should be understood by the one skill in the art the 3 ingredient containers illustrated are given as an example only, and the invention is not limited to a specific number of ingredient containers.

In some embodiments, container storage 120 may be divided into two compartments, one compartment for storing the bowls (e.g., bowls 51 illustrated in FIG. 4A) of container 50 and one for storing the cover (e.g., cover 53 illustrated in FIG. 4B) of container 50. In some embodiments, cooking device 100 may include a conveying unit, not illustrated, for covering each bowl after the filling of the bowl with dry ingredients.

Reference is now made to FIG. 3 which is an illustration of another automatic cooking device according to some embodiments of the invention. Automatic cooking device 100 may include a cooking chamber 130, a liquid supply system 140, an energy source 150, a vibration generator 160; and a controller 170 all being contained in a housing 110. Cooking chamber 130, liquid supply system 140, energy source 150, vibration generator 160; and controller 170 may be substantially the same components discussed above with respect to FIG. 1. In some embodiments, automatic cooking device 100 may further include a sensor 180 and a power source 190, also discussed above.

In some embodiments, automatic cooking device 100 may include both storage container 120 for holding empty or pre-loaded containers 50 filled with at least one dry ingredient 55, and one or more ingredient containers 122, 124, and 126. In some embodiments, at least some of one or more ingredient containers 122, 124, and 126 and storage container 120 may be equipped with oxygen and/or humidity sensors, as discussed above.

In some embodiments, the humidity levels may be controlled passively by adding silica gel, or molecular sieve to at least one of the ingredient containers 122, 124 and 124 and/or storage container 120. In some embodiments, the oxygen and humidity levels may be actively controlled, for example, by providing ventilation (e.g., by fans, blowers, etc.) to one or all ingredient containers 122, 124 and 124, and/or storage container 120 for example, based on the humidity level and the oxygen level measurements.

In some embodiments, controller 170 may control the provision of cooking container 50 from storage container 120, and determine if additional ingredients need to be added to cooking container 50 based on the instructions to cook a meal. For example, cooking containers 50 may be filled with dry pasta, and one or more ingredient containers 122, 124, and 126 may each be filled with a mixture of dry ingredients for making a different source. Once a user makes a meal selection, controller 170 may control the controllable door/valve of the required cooking container to open and provide the required amount of dry mixture in one or more of ingredients containers 122, 124, 126 to the dry pasta.

In some embodiments, automatic cooking device 100 may include a conveyor 125 configured to convey cooking container 50 to cooking chamber 130, for example, from storage container 120.

Reference is now made to FIGS. 4A and 4B which are simulated illustrations of nonlimiting examples for an automatic cooking device and a cooking container according to some embodiments of the invention.

In some embodiments, housing 110 may have at least one opening 115 allowing a user to open a door/cover of cooking chamber 130 in order to extract cooking container 50. In some embodiments, at least one opening 115 may cover a “collection zone” that may not specifically be the door of cooking chamber 130. In such case, cooking chamber 130 may have an automatic door configured to be open following the end of cooking, and cooking container may slide/convey form cooking chamber 130 to the “collection zone” to be collected via at least one opening 115.

In some embodiments, housing 110 may have at least one other opening comprising a user interface 177, included in or in communication with controller 170, for allowing a user to enter a selection of meals, and pay for the meal via payment module 178. User interface 177 may be or may include, a touchscreen, a keyboard, a voice recognition system, a microphone, a loudspeaker, and the like. In some embodiments, controller 170 may communicate (via communication unit 176, discussed below) with a user device (e.g., smartphone, smartwatch, tablet, etc.) and receive the selected meal and optionally also payment from the user device.

Cooking container 50 may be disposable (as shown) or reusable. Cooking container 50 may have a bowl 51 and a detachable cover 53, for introducing the dry ingredients and/or extracting the cooked meal. In some embodiments, cooking container 50 may include an inlet 57 for receiving liquid(s) from liquid supply unit 140. In some embodiments, cooking container 50 may include a release exit 58 for releasing excess vapor pressure. In some embodiments, inlet 57 and exit 58 may be the same element or two different elements, selected from, a hole covered by a small tongue, a single or bidirectional valve, and the like.

In some embodiments, bowl 51 and detachable cover 53 are made from materials suitable for use in a microwave oven, for example, dielectric materials. In some embodiments, at least a portion of bowl 51 and detachable cover 53 may be transparent to IR radiation, to be used in an IR oven. In some embodiments, at least one of bowl 51 and detachable cover 53 may include a magnetic metallic element configured to be heated by a magnetic flux from an induction heater.

Reference is now made to FIG. 5 which is an illustration of a microwave oven 30 according to some embodiments of the invention. Microwave oven 30 can be used as cooking chamber 130 of cooking device 100 or may be used for any other purpose. For example, microwave oven 30 may be a standalone microwave oven for domestic use, industrial use, laboratory use, and the like. Microwave oven 30 may include a microwave cavity 32, a microwave source 34, and a vibration generator 36. Vibration generator 36 may be configured to vibrate a load 5 placed in microwave cavity 32. In some embodiments, vibration generator 36 may include a vibration motor rotating at 10 to 10000 RPM, having a shift of 1 mm to 150 mm, at a weight of between 0.1 to 2000 grams. In a nonlimiting example, vibration generator 36 may be for example Vybronics™ vibration motor, for example, VJQ24, VJP 12, VJP16, and the like.

In some embodiments, load 5 may be any load capable of being heated by microwave energy, for example, a food product in bowl 51, a laboratory sample, any aqueous solution, and the like.

Microwave source 34 may include any suitable microwave generator, such as, a magnetron, a solid state microwave generator, etc. and may further include elements configured to direct the microwaves into microwave cavity 32, for example, waveguides.

In some embodiments, vibration generator 36 may be assembled below the floor of microwave cavity 32, and the floor may have an opening allowing vibration generator 36 to vibrate only load 5, as illustrated. Additionally or alternatively, one or more vibration generators 36 may be and assembled across any one of the walls of microwave cavity 32, and microwave oven 30 may further include an arm configured to hold load 5 and be vibrated by vibration generator 36, not illustrated.

In some embodiments, microwave oven 30 may further include at least one sensor 31 for sensing a property of load 5 placed in microwave cavity 32. At least one sensor 31 may be selected from, a temperature sensor (e.g., an IR\thermal sensor, an IR \thermal camera, a thermocouple, etc.) an optical camera, a humidity sensor, a pH sensor, a pressure sensor, and the like.

In some embodiments, microwave oven 30 may further include a controller, such as controller 170 configured to receive measurements of the at least one property from at least one sensor 31; and control at least vibration generator 36 to vibrate load 5 based on the received measurements.

In some embodiments, controller 170 is further configured to control microwave source 34 based on the received measurements.

In some embodiments, controller 170, is further configured to control at least one of, vibration generator 36 and microwave source 34 to provide substantially homogeneous heating to load 5. For example, controller 170 may continuously monitor the spatial/surface temperature of load 5 (e.g., by IR camera) and may control the duration of operation, the synchronization between microwave source 34 and vibration generator 36, and the power provided to at least one of vibration generator 36 and microwave source 34, until a homogeneous heating to a desired temperature is achieved.

In some embodiments, microwave oven 30 may further include a power source 39 for providing electrical power to microwave oven 30.

Referring now to FIG. 6, which is a block diagram of a controller for an automatic cooking device according to some embodiments of the invention. Controller 170 may include a processor 172 that may be, for example, a central processing unit (CPU) processor, a chip or any suitable computing or computational device. Processor 172 (or one or more processors, possibly across multiple units or devices) may be configured to carry out methods described herein, and/or to execute or act as the various modules, units, etc. More than one computing controller 170/172 may be included in system 100 according to embodiments of the invention.

Controller 170 may include a memory 174 that may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 174 may be or may include a plurality of possibly different memory units. Memory 174 may be a computer or processor non-transitory readable medium, or a computer non-transitory storage medium, e.g., a RAM. In one embodiment, a non-transitory storage medium such as memory 174, a hard disk drive, another storage device, etc. may store instructions or code which when executed by a processor may cause the processor to carry out methods as described herein.

Memory 174 may be stored thereon, an operating system, an executable code, and a database according to some embodiments of the invention.

Controller 170 may further include a communication unit 176 that may include one or more input and output devices. For example, the input devices may be or may include any suitable input devices, components or systems, e.g., a detachable keyboard or keypad, a mouse and the like. In another example, the output devices may include one or more (possibly detachable) displays or monitors, speakers and/or any other suitable output devices. Any applicable input/output (I/O) devices may be connected to controller 170. For example, a wired or wireless network interface card (NIC), a universal serial bus (USB) device or external hard drive may be included in the input devices and/or the output devices.

Reference is now made to FIG. 7 which is a flowchart of a method of controlling an automatic cooking device to cook a meal according to some embodiments of the invention. The method of FIG. 7 can be executed by a controller, such as controller 170, or any other suitable controller.

In step 710, the controller may receive instructions to cook a meal. For example, the controller 170 may receive the instructions from user interface 177 and/or from a user device (e.g., smartphone, smartwatch, tablet) via communication unit 176. The user may select a meal from a group of optional meals displayed on a screen of user interface 177, or the screen of the user device. In some embodiments, the user may modify a selected meal, for example, request to add more salt, to exclude a specific ingredient and the like.

In step 720, a cooking container and at least one dry ingredient may be provided to a cooking chamber. For example, controller 170 may control a conveyor to bring cooking container 50 filled/pre-loaded with all the required dry ingredients required to cook the meal from container storage 120. In some embodiments, two or more different types of mixtures may each be pre-loaded to two different cooking containers 50 and sorted into two or more container storages 120, and the controller may control the conveyor to bring the cooking container pre-loaded with dry ingredients 55 of the selected meal.

In some embodiments, the method may include adding at least one dry ingredient, form an ingredient container, at a desired amount. In some embodiments, the desired amount is determined based on the meal to be cooked. In some embodiments, providing cooking container and at least one dry ingredient may include providing to the cooking container a first dry ingredient at a first amount from a first dry ingredient container and providing a second dry ingredient at a second amount from a second dry ingredient container. For example, controller 170 may control a conveyor to convey an empty cooking container 50 for storage 120, and to fill the cooking container with predetermined amounts of dry ingredients from one or more ingredient containers 122, 124 and 126. The predetermined amounts and the type of dry ingredients (e.g., dry ingredients 52, 54, and 56) may be determined based on the selected meal and any specific requirements or instructions received, e.g., via user interface 177 at step 710.

In yet another example, controller 170 may control a conveyor to convey a partially filled cooking container 50 from storage 120, and to be further filled with predetermined amounts of dry ingredients from two or more ingredient containers 122, 124 and 126.

In some embodiments, the conveyor may convey cooking container 50 into cooking chamber 130.

In step 730, a predetermined amount of liquid may be provided to the cooking container from a liquid supply unit, thereby obtaining a mixture. Controller 170 may control a valve and/or a pump included in liquid supply unit 140 to provide the predetermined amount of liquid to cooking container 50, for example, via inlet 57 in cooking container cover (53 in FIG. 4B). In some embodiments, the amount of liquid and/or type of liquid may be determined based on the instructions and the selected meal. For example, a lookup table associating amounts of liquids with specific meals may be stored in memory 174 or any other database associated with controller 170. The amount of liquid associated with each specific meal may be determined experimentally or may be calculated based on the type and amount of dry ingredients. In some embodiments, if two or more types of liquids can be provided to container 50 (e.g., water and wine) controller 170 may control liquid supply unit 140 to provide a selected liquid or a mixture of two or more liquids.

In step 740, the controller may determine at least one property of the mixture prior to, or during cooking, based on measurements received from at least one sensor. For example, controller 170 may receive temperature measurements from a temperature sensor 180 and may determine the temperature of at least one of: the pre-cooked mixture and cooking container 50 holding the pre-cooked mixture. In some embodiments, the temperature may be a spatial/surface temperature of the mixture and/or cooking container 50. In some embodiments, the at least one property may be selected from, temperature, humidity, pH, pressure inside cooking container 50 and the like. In some embodiments, the at least one property may be determined and monitored throughout the cooking process, either continuously or every predetermined duration (e.g., every 2 seconds, 10 seconds, 30 seconds, etc.).

In step 750, the controller may operate an energy source to provide energy to the mixture and a vibration generator to provide vibrations to the mixture based on the determined property; thereby obtaining the cooked meal. For example, controller 170 may operate energy source 150 and vibration generator 160 to simultaneously provide energy and vibration to cooking container 50 and the mixture until a homogenous distribution of a required temperature is measured/determined by sensor 180 and the may further hold the mixture at this temperature for additional amount of time (e.g., 1 to 180 seconds). In some embodiments, the vibrations may be applied to cause wetting (e.g., homogenous wetting) of the liquid to all dry ingredients in container 50 and homogenous mixture of the ingredients in container 50. The predetermined amount of time and the temperature may be determined based on the selected meal (e.g., from lookup table). In some embodiments, the energy and/or vibrations may be applied in sequences, pulses, or continuously.

Alternatively, the controller may operate an energy source to provide energy to the cooking container and a vibration generator to provide vibrations to the cooking container based solely on the received instructions. For example, cooking conditions may be stored in a lookup table and associated with each selected meal. The cooking conditions may include the application of the energy and/or vibrations in sequences, pulses, in a continuous manner, and any combination thereof.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. An automatic cooking device comprising:
(i) a cooking chamber capable of holding a closable cooking container configured to hold at least one dry ingredient;
(ii) a liquid supply unit for providing a predetermined amount of liquid to the cooking container;
(iii) an energy source configured to provide energy to a mixture of the at least one dry ingredient and the liquid inside the cooking container when placed in the cooking chamber;
(iv) a vibration generator configured to vibrate the mixture of the at least one dry ingredient and the liquid inside the cooking container in the cooking chamber; and
(v) a controller configured to:
receive instructions to cook a meal;
control the provision of the cooking container with the at least one dry ingredient to the cooking chamber;
control the provision of the predetermined amount of liquid to the cooking container from the liquid supply unit; and
control the operation of the energy source and the vibration generator, simultaneously, based on the received instructions to cook the meal.

2. The automatic cooking device of claim 1, further comprising (vi) a housing containing elements (i) to (v).

3. The automatic cooking device of claim 1, wherein the controller is further configured to associate the received instructions to cook the meal with at least of the following parameters: power of the energy source; duration of operation of the energy source; frequency of the vibration generator; an amplitude of the vibration generator; and vibration type.

4. The automatic cooking device of claim 1, further comprising at least one sensor configured to sense at least one of: a property of a mixture, and a property of the cooking container inside the cooking chamber; and wherein the controller is further configured to:
receive, from the at least one sensor, measurements of the property; and
control the operation of the energy source and the vibration generator also based on the received measurements.

5. (canceled)

6. (canceled)

7. (canceled)

8. (canceled)

9. (canceled)

10. The automatic cooking device according to of claim 1, further comprising at least one storage container containing cooking containers filled with at least one dry ingredient.

11. (canceled)

12. (canceled)

13. (canceled)

14. (canceled)

15. The automatic cooking device of claim 2, wherein the housing is characterized by a width of between 30 to 100 cm, a length of between 50 to 500 cm, and a height of between 100 to 400 cm.

16. The automatic cooking device of claim 1, wherein the cooking container comprises an inlet for receiving the at least one dry ingredient.

17. The automatic cooking device of claim 16, wherein the cooking container comprises an inlet for receiving the liquid.

18. (canceled)

19. (canceled)

20. (canceled)

21. (canceled)

22. The automatic cooking device of claim 1, wherein the energy source is a microwave generator, and the cooking chamber is a microwave cavity.

23. The automatic cooking device of claim 1, wherein the energy source is an induction heater, and the cooking container comprises a metallic magnetic insert.

24. The automatic cooking device of claim 1, wherein the energy source is IR radiation.

25. (canceled)

26. The automatic cooking device of claim 1, wherein the vibration generator generates vibration at a frequency of between a frequency of between 10 Hz and 600 kHz.

27. The automatic cooking device of 3, wherein the sensor is selected from: IR Camera, pressure sensor, CMOS camera, CCD camera, temperature sensor, vibration sensor, humidity sensor, volume sensor, and pH sensor.

28. (canceled)

29. The automatic cooking device of claim 1, further comprising at least one conveyor configured to convey the cooking container to the cooking chamber.

30. A method of controlling automatic cooking device to cook a meal comprising:
receiving instructions to cook a meal;
providing a cooking container and at least one dry ingredient to a cooking chamber;
supplying a predetermined amount of liquid to the cooking container from a liquid supply unit, thereby obtaining a mixture;
determining at least one property of the mixture, based on measurements received from at least one sensor; and
simultaneously operating an energy source to provide energy to the mixture and a vibration generator to provide vibrations to the mixture based on the determined property; thereby obtaining the cooked meal.

31. The method of claim 30, wherein providing comprises adding the at least one dry ingredient, form an ingredient container, at a desired amount to the cooking container.

32. The method of claim 31, wherein the desired amount is based on the meal to be cooked.

33. The method of any one of claim 30, wherein providing comprises providing to the cooking container a first dry ingredient at a first amount from a first dry ingredient container and a second dry ingredient at a second amount from a second dry ingredient container.

34. The method of claim 30, wherein providing comprises receiving a cooking container from a storage container, wherein the cooking container comprises the at least one dry ingredient.

35. (canceled)

36. (canceled)

37. A microwave oven, comprising:
a microwave cavity;
a microwave source;
a vibration generator configured to vibrate a load placed in the microwave cavity, and wherein the vibration generator comprising a vibration motor rotating at 10 to 10000 RPM, having a shift of 1 mm to 150 mm, at a weight of between 0.1 to 2000 grams; and
a controller configured to:
simultaneously operate the microwave source and the vibration generator.

38. (canceled)

39. (canceled)

40. (canceled)

41. (canceled)
